(19) United States
(12) Patent Application Publication
(10) Pub. No.: US 2003/0181195 A1
(43) Pub. Date: Sep. 25, 2003

(54) Method of SNMP printing device/mobile device communication for assuring proper imaging device selection

(76) Inventors: Robert D. Christiansen, Boise, ID (US); Patrick O. Sandfort, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/104,924

(22) Filed: Mar. 21, 2002

(51) Int. Cl. H04M 3/00

(52) U.S. Cl. 455/414.1; 455/418

(57) ABSTRACT

This invention relates to a method for assuring that a selected imaging device is the desired one. Such structures of this type, generally, send messages from the user's mobile device to the desired imaging device that notifies the user that this is indeed the imaging device that the user wants to use. The message may, for example, appear on a display located on the imaging device that assures the user that the desired imaging device will be used. For example, a phrase, such as “Hello User”, may be used to appear on the imaging device display as a means of assurance so that the user can download the print job information from the mobile device to the imaging device and the document can be printed.

### FIELD OF THE INVENTION

This invention relates to a method for assuring that a selected imaging device is the desired one. Such structures of this type, generally, send messages from the user's mobile device to the desired imaging device that notifies the user that this is indeed the imaging device that the user wants to use. The message may, for example, appear on a display located on the imaging device that assures the user that the desired imaging device will be used. For example, a phrase, such as “Hello User”, may be used to appear on the imaging device display as a means of assurance so that the user can download the print job information from the mobile device to the imaging device and the document can be printed.

### DESCRIPTION OF THE RELATED ART

Prior to the present invention, as set forth in general terms above and more specifically below, it is known, in the proximity detection art, to employ a variety of location methods to detect the location of one object with respect to another. Exemplary of such prior art are U.S. Pat. No. 5,995,046 (′046) to D. K. Belcher et al., entitled “Radio Geo-Location System with Advanced First Received Wavefront Arrival Determination,” U.S. Pat. No. 6,134,448 (′448) to Y. Shoji et al., entitled “System for Detecting Positional Information,” U.S. Pat. No. 6,222,482 (′482) to A. Gueziec, entitled “Hand-Held Device Providing a Closest Feature Location in a Three-Dimensional Geometry Database,” U.S. Pat. No. 6,259,405 (′405) to B. H. Stewart et al., entitled “Geographic Based Communications Service,” U.S. Pat. No. 6,292,106 (′106) to J. C. Solinsky et al., entitled “Acoustical System and Method for Simultaneously Locating and Tracking Multiple Personnel in Rooms of a Building,” and U.S. Pat. No. 6,327,535 (′535) to S. S. Evans et al., entitled “Location Beaconing Methods and Systems.” While the ′046, ′448, ′482, ′405, ′106, and ′535 references disclose a variety of location methods, they are unable to provide assurance that the user is using the desired imaging device. Therefore, a further advantageous system, then, would be presented if the location system were able to provide assurance to the user that the user was using the proper imaging device.

It is also known, in the proximity detection art, to sense the proximity of the object using near-field effects. Exemplary of such prior art is U.S. Pat. No. 5,459,405 (′405) to G. D. Wolff et al., entitled “Method and Apparatus for Sensing Proximity of an Object Using Near-Field Effects.” While the ′405 reference teaches the use of near-field effects to determine the proximity of one object with respect to another, again, there is no teaching, suggesting or even appreciation for assuring the user that the user is using the desired imaging device. Therefore, a still further advantageous system, then, would be presented if the location system could provide assurance to the user that the desired imaging device is being used.

It is apparent from the above that there exists a need in the art for a imaging device assurance system which is capable of locating a desired imaging device, but which provides assurance that the user is using the desired imaging device. It is a purpose of this invention to fulfill this and other needs in the art in a manner more apparent to the skilled artisan once given the following disclosure.

### SUMMARY OF THE INVENTION

Generally speaking, this invention fulfills these needs by providing a method of assuring proper imaging device selection, wherein the method is comprised of the steps of: determining a location of a desired imaging device;

interacting between a user's mobile device and an actual imaging device to determine if the actual imaging device is the desired imaging device; downloading information to be printed from the mobile device to the desired imaging device; and printing the information on the desired imaging device.

In certain preferred embodiments, the mobile device can be, but is not limited to, a computer, a laptop computer, a personal digital assistant (PDA) or the like. Also, the interacting step includes the steps of having the user download an assurance signal from the mobile device to the actual imaging device and monitoring the actual imaging device to determine if the assurance signal arrived at the actual imaging device. The assurance signal can be, but is not limited to, an electronic signal that may appear on the display of the actual imaging device, such as the phrase “Hello User.” The imaging device can be, but is not limited to, a printing device, a digital sender, a scanner or the like.

In another further preferred embodiment, the user can determine whether or not the imaging device that the user is standing in front of is the imaging device that the user wants to print from.

The preferred imaging device assurance system, according to this invention, offers the following advantages: ease in assuring that the proper imaging device is being used; ease in determining the location of the desired imaging device; ease of imaging; and excellent economy. In fact, in many of the preferred embodiments, these factors of ease in assuring that the proper imaging device is being used, ease in determining the location of the desired imaging device, and ease of imaging are optimized to an extent that is considerably higher than heretofore achieved in prior, known printing device proximity detection systems.

The above and other features of the present invention, which will become more apparent as the description proceeds, are best understood by considering the following detailed description in conjunction with accompanying drawing figures, wherein like characters represent like parts throughout the several views and in which:

### BRIEF DESCRIPTION OF THE DRAWINGS

FIGS. 1A, 1B, and 1C are a flowchart that illustrates a method for assuring proper imaging device selection, according to one embodiment of the present invention.

### DETAILED DESCRIPTION OF INVENTION

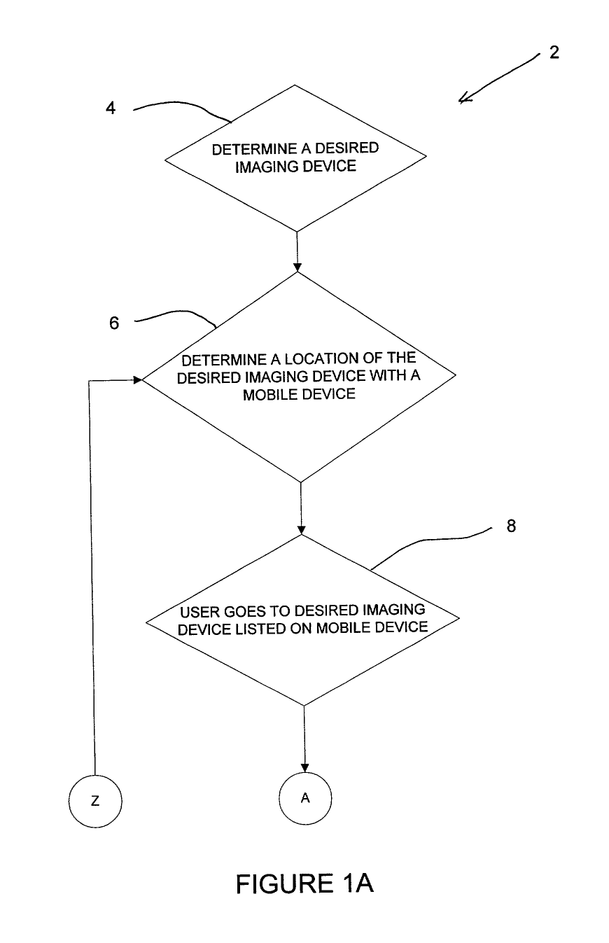

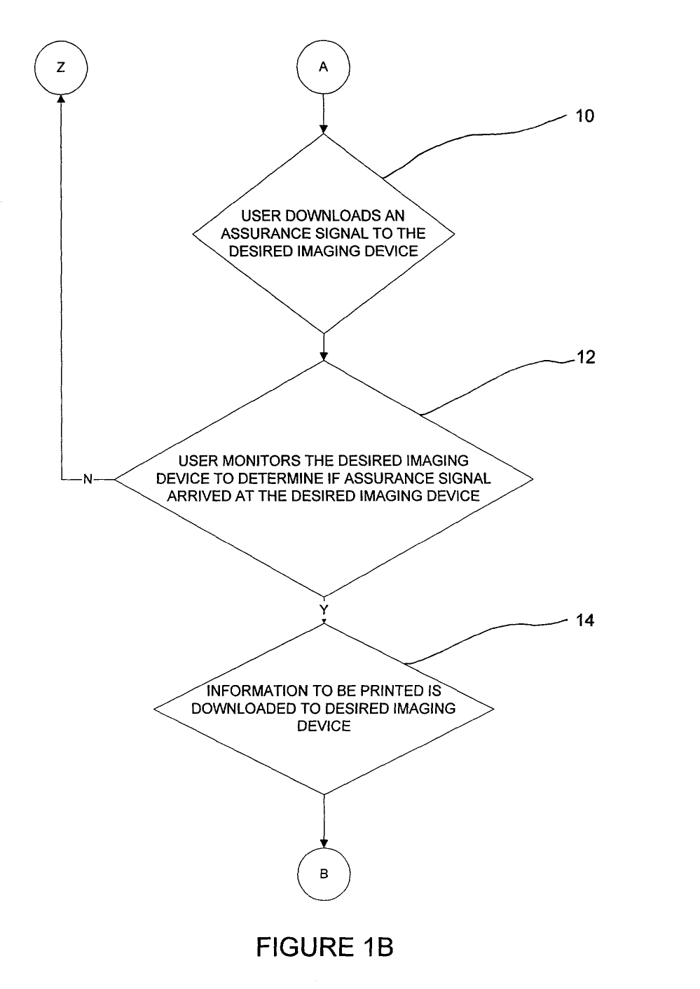

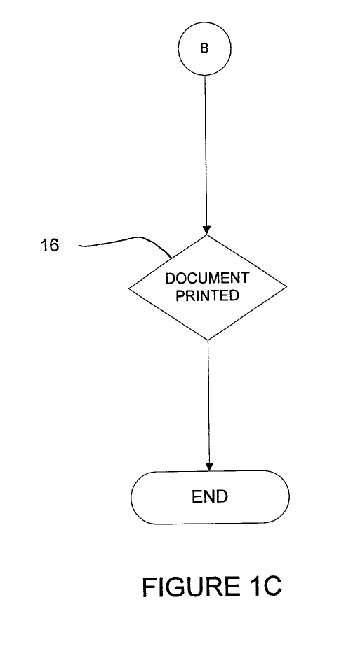

With reference to FIGS. 1A, 1B, and 1C, there is illustrated one preferred embodiment for use of the concepts of this invention. Method 2 for assuring proper imaging device selection is illustrated in FIGS. 1A, 1B, and 1C. Method 2 includes, in part, the steps of determining a desired imaging device which is to be used by the user (step 4), determining a location of the desired imaging device with a mobile device (step 6), having the user go to the imaging device listed on the mobile device (step 8), downloading an assurance signal from the mobile device to the actual imaging device that the user is standing in front of (step 10), monitoring the actual imaging device to determine if the assurance signal has arrived at the desired imaging device (step 12), downloading print job information to be printed from the mobile device to the desired imaging device (step 14), and printing the document (step 16).

With respect to step 6, it is to be understood that the mobile device can be, but is not limited to, a computer, a laptop computer, a personal digital assistant (PDA) or the like. Typically, the mobile device scans a conventionally prepared list of network addresses of all the imaging devices in the area defined by the network. For example, the network list may refer to a listing of all the printers in a local area network (LAN). Also, the prior art locating techniques described above can be used to determine the location of a desired imaging device. Finally, it is to be understood that the imaging device can be, but is not limited to, a printing device, a digital sender, a scanner or the like.

With respect to steps 6-12, a Simple Network Management Protocol (SNMP) is used during the interaction between the imaging device and the mobile device. SNMP is a widely used, common communications protocol that is found in almost all conventional imaging devices. SNMP allows the imaging devices or agents to provide information about themselves, such as what the imaging device can do and what can be controlled in the imaging device, in a common storage area or MIB. The information about a particular imaging device or agent can then be accessed by a user or requester, such as the user's mobile device.

With respect to step 10, the user may, for example, download an electronic signal from the mobile device to the actual imaging device that is in the form of a confirmation signal, such as the phrase “Hello User.” In this manner, when the user looks at a display (not shown), for example, on the actual imaging device, if the user has located the proper imaging device, the phrase “Hello User” should appear on the display of the actual imaging device (step 12). If the phrase does not appear on the actual imaging device display, the user may then have to double-check the location of the desired imaging device, quite possibly, move to the location of that desired imaging device and repeat the process. It is also to be understood that an assurance page or other such document could be printed/imaged by the actual imaging device to assure the user that the user was using the proper imaging device.

Finally, the user may, for example, activate the on/off button of the actual imaging device. This activation may cause the imaging device to go from the on-state to the off-state or vice versa. The SNMP, as previously described, could then be utilized during the interaction between the actual imaging device and the mobile device in order to determine which imaging device has experienced a change in the desired variable (turned from the on-state to the off-state). If the network address of the imaging device that experienced the change in the desired variable (turned from the on-state to the off-state) is the same as the proper imaging device that the user wants to use, then the user is assured that this is the proper imaging device.

With respect to step 14, once the user is located in front of listed imaging device, the imaging device conventionally downloads a unique identifier to the user's mobile device. It is to be understood that the term “unique identifier” can be, but is not limited to, a network address or any such identifier that is unique to that particular imaging device. After the unique identifier has been downloaded to the user's mobile device, the mobile device will then be able to conventionally download the print job information on the mobile device to the imaging device. Finally, the document is printed, as shown in step 16.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method of assuring proper imaging device selection, comprising the steps of:
determining a location of a desired imaging device;
interacting between a user's mobile device and an actual imaging device to determine if said actual imaging device is said desired imaging device;
downloading information to be printed from said mobile device to said desired imaging device; and
printing the information on said desired imaging device.

2. The method, as in claim 1, wherein said determining step is further comprised of the step of:
using said mobile device to query a network list.

3. The method, as in claim 1, wherein said interacting step is further comprised of the steps of:
downloading an assurance signal from said mobile device to said actual imaging device; and
monitoring said actual imaging device to determine if said assurance signal arrived at said actual imaging device.

4. The method, as in claim 3, wherein said assurance signal is further comprised of:
a displayable phrase.

5. The method, as in claim 3, wherein said monitoring step is further comprised of the step of:
viewing a display on said actual imaging device.

6. The method, as in claim 1, wherein said interacting step is further comprised of the step of:
utilizing a common communications protocol between said actual imaging device and said mobile device.

7. The method, as in claim 6, wherein said common communications protocol is further comprised of:
a Simple Network Management Protocol (SNMP).

8. The method, as in claim 1, wherein said mobile device is further comprised of:
a laptop computer.

9. The method, as in claim 1, wherein said mobile device is further comprised of:
a personal digital assistant.

10. The method, as in claim 1, wherein said imaging device is further comprised of:
a printing device.

11. The method, as in claim 3, wherein said monitoring step is further comprised of the step of:
printing an assurance page on said actual imaging device.

12. A program storage medium readable by a computer, tangibly embodying a program of instructions executable by the computer to perform method steps for assuring proper imaging device selection, comprising the steps of:
determining a location of a desired imaging device;
interacting between a user's mobile device and an actual imaging device to determine if said actual imaging device is said desired imaging device;
downloading information to be printed from said mobile device to said desired imaging device; and
printing the information on said desired imaging device.

13. The method, as in claim 12, wherein said determining step is further comprised of the step of:
using said mobile device to query a network list.

14. The method, as in claim 12, wherein said interacting step is further comprised of the steps of:
downloading an assurance signal from said mobile device to said actual imaging device; and
monitoring said actual imaging device to determine if said assurance signal arrived at said actual imaging device.

15. The method, as in claim 14, wherein said assurance signal is further comprised of:
a displayable phrase.

16. The method, as in claim 14, wherein said monitoring step is further comprised of the step of:
viewing a display on said actual imaging device.

17. The method, as in claim 12, wherein said interacting step is further comprised of the step of:
utilizing a common communications protocol between said actual imaging device and said mobile device.

18. The method, as in claim 17, wherein said common communications protocol is further comprised of:
a Simple Network Management Protocol (SNMP).

19. The method, as in claim 14, wherein said monitoring step is further comprised of the step of:
printing an assurance page on said actual imaging device.
